(19) United States
(12) Patent Application Publication
(10) Pub. No.: US 2017/0164324 A1
(43) Pub. Date: Jun. 8, 2017

(54) METHODS AND APPARATUS FOR OPTIMIZING DATA PERFORMANCE IN A WIRELESS DEVICE

(71) Applicant: QUALCOMM Incorporated, San Diego, CA (US)

(72) Inventors: Alvin Siu-Chung Ng, Hong Kong (HK); Chun Chung Patrick Chan, Hong Kong (HK); Tsun Sang Cheong, Hong Kong (HK); Tak Wai Wu, Hong Kong (HK)

(21) Appl. No.: 14/959,860

(22) Filed: Dec. 4, 2015

(51) Int. Cl. H04W 68/02; H04W 72/04; H04W 4/06; H04W 24/02

(52) U.S. Cl. CPC H04W 68/02; H04W 24/02; H04W 72/0446; H04W 4/06

(57) ABSTRACT

Disclosed are methods and apparatus optimizing the performance of a radio access technology, such as LTE, in a single radio wireless communication system supporting multiple radio access technologies, such as both LTE and 1x CDMA. The methods and apparatus effectuate this optimization in a single radio LTE (SRLTE) device, for example, through increasing system parameters, such as Slot Cycle Index (SCI) related to a maximum allowed periodicity of when a wireless device tune away from a LTE data call to monitor paging from 1x CDMA. Increasing the SCI value in the wireless device reduces the periodicity of 1x CDMA paging tune away from an LTE data call, thereby optimizing the LTE performance.

### BACKGROUND

Field

The present disclosure relates generally to methods and apparatus for optimizing Long Term Evolution (LTE) data performance in a wireless device, and more specifically to optimizing LTE data performance in Single Radio LTE (SRLTE) devices.

Background

Certain wireless devices have the capability to receive signals from two or more Radio Access Technologies (RATs) using a single radio. One example of such devices is known as Single Radio Long Term Evolution (LTE) or SRLTE. In SRLTE devices, a User Equipment (UE) or Mobile Station (MS) may simultaneously receive signals from an LTE wireless network and a Code Division Multiple Access (CDMA) 2000 1x wireless network.

In a 1x SRLTE device (i.e., 1x CDMA Single Radio LTE or similar GSM devices), the UE has to tune away to a 1x CDMA system to perform paging monitoring. Typically, the 1x tuning away time is between 60 to 130 milliseconds (ms), even under favorable conditions such as no cell change, no re-read OVH, or no signaling exchange. Thus, if the LTE portion of a UE is in a connected mode transferring data, the LTE data transmission will be suspended while the UE performs a 1x CDMA tune away, resulting in LTE data throughput degradation even under the best conditions.

Additionally, it is noted that paging delay in SRLTE devices is dependent on the slot cycle index (SCI) for the Paging Channel in the system, which is typically determined by the network. For 1x CDMA, for example, the Paging Channel, which is a shared channel that all MS's listen for various information including pages, is divided into “slots”. The SCI determines how frequently the MS's assigned slot occurs in a network. For example, if the SCI=0, the MS wakes up every 1.28 seconds, if the SCI=1, the MS wakes up every 2.56 seconds, and so on up to a typical maximum value of 7 (i.e., 163.84 seconds). Thus, the larger an SCI, the less frequently a UE/MS will tune away to check 1x paging. Conversely, the smaller the SCI value, the more frequently a UE/MS will tune away to check 1x paging, which further degrades LTE data throughput. This may also be exacerbated by the fact that networks typically set an SCI value that is not increasable, and the standards direct that the smallest number be used for the SCI value. Furthermore, even if a network allows increase in the SCI to reduce the frequency of tune away, networks will also establish maximum SCI values (MAX_SLOT_CYCLE_INDEX) that cannot be exceeded, which hampers efforts to increase LTE data performance even though the SCI may be adjusted.

There is a need in the art for methods and apparatus for better optimizing dual network devices by allowing the frequency of tune away to a first network (e.g., 1x CDMA) for paging monitoring to be reduced, thereby increasing data performance for reception over the second network (e.g., LTE).

### SUMMARY

According to an aspect, a method for optimizing the performance of a radio access technology in a wireless communication system supporting multiple radio access technologies is disclosed The method includes monitoring a call paging channel from a first radio access technology received at a wireless device, and then determining at least one system parameter received over the call paging channel, the at least one system parameter related to a maximum allowed periodicity of when the wireless device may tune away from a second radio access technology to monitor paging from the first radio access technology. Additionally, the method includes determining whether the maximum allowed periodicity determined from the at least one system parameter is greater than a preferred tune away periodicity stored in the wireless device. If the maximum allowed periodicity is greater than the preferred tune away periodicity, the method includes increasing the at least one system parameter in the wireless device.

According to another aspect, a device configured for optimizing the performance of a radio access technology in a wireless communication system supporting multiple radio access technologies is disclosed. The device includes at least one processor configured for monitoring a call paging channel from a first radio access technology received at a wireless device. The processor is also configured for determining at least one system parameter received over the call paging channel, the at least one system parameter related to a maximum allowed periodicity of when the wireless device may tune away from a second radio access technology to monitor paging from the first radio access technology, and determining whether the maximum allowed periodicity determined from the at least one system parameter is greater than a preferred tune away periodicity stored in the wireless device. Additionally, the processor is configured for increasing the at least one system parameter in the wireless device when the when the maximum allowed periodicity is greater than the preferred tune away periodicity.

According to yet another aspect, an apparatus for optimizing the performance of a radio access technology in a wireless communication system supporting multiple radio access technologies is disclosed. The apparatus includes means for monitoring a call paging channel from a first radio access technology received at a wireless device. Further, the apparatus includes means for determining at least one system parameter received over the call paging channel, the at least one system parameter related to a maximum allowed periodicity of when the wireless device may tune away from a second radio access technology to monitor paging from the first radio access technology. The apparatus also includes means for determining whether the maximum allowed periodicity determined from the at least one system parameter is greater than a preferred tune away periodicity stored in the wireless device. Moreover, the apparatus includes means for increasing the at least one system parameter in the wireless device when the when the maximum allowed periodicity is greater than the preferred tune away periodicity.

According to still another aspect, a computer program product comprising computer-readable medium is disclosed. The medium includes code for causing a computer to monitor a call paging channel from a first radio access technology received at a wireless device in a wireless communication device supporting multiple radio access technologies. Furthermore, the medium includes code for causing a computer to determine at least one system parameter received over the call paging channel, the at least one system parameter related to a maximum allowed periodicity of when the wireless device may tune away from a second radio access technology to monitor paging from the first radio access technology. The medium also includes code for causing a computer to determine whether the maximum allowed periodicity determined from the at least one system parameter is greater than a preferred tune away periodicity stored in the wireless device. Additionally, the medium includes code for causing computer to increase the at least one system parameter in the wireless device when the when the maximum allowed periodicity is greater than the preferred tune away periodicity.

### BRIEF DESCRIPTION OF THE DRAWINGS

FIG. 1 is an illustration of an exemplary environment in which the presently disclosed methods and apparatus may implemented.

FIG. 2 is an illustration of a flow diagram of an exemplary method for increasing the SCI within a UE device.

FIG. 3 is an illustration of a flow diagram of an exemplary method for causing a network to increase the allowable or maximum SCI value.

FIG. 4 illustrates a block diagram of an exemplary wireless apparatus configured to optimize data performance in the apparatus.

FIG. 5 illustrates an exemplary method for optimizing LTE performance that combines features of the methods illustrated in FIGS. 2 and 3.

FIG. 6 illustrates an exemplary apparatus that may be used to implement the processes or operations of FIGS. 2 and 5.

FIG. 7 illustrates an exemplary apparatus that may be used to implement the processes or operations of FIGS. 3 and 5.

### DETAILED DESCRIPTION

The presently disclosed apparatus and methods afford better optimization of one network's data in a dual network device that is adversely affecting by tune away to another network by decreasing the tune away frequency. In particular, an SRLTE UE device may be configured to increase its in-use Slot Cycle Index (SCI) in order to decrease 1x CDMA tune away. In a further aspect, a UE or network station (e.g., an eNodeB or Base Station) may be configured to effect change of the network maximum SCI (MAX_SLOT_CYCLE_INDEX); i.e., allowing network tuning of the MAX_SLOT_CYCLE_INDEX, which allows for a reduced frequency of tune away for 1x CDMA paging. In yet a further aspect, both increase of the SCI and tuning the MAX_SLOT_CYCLE_INDEX may be utilized in conjunction to achieve even greater optimization. Additionally, it is noted that the present methods and apparatus also afford increased power savings as the UE will not tune away as frequently to check 1x CDMA paging.

For purposes of the following discussion, it is noted that the word “exemplary” is used herein to mean “serving as an example, instance, or illustration.” Any example described herein as “exemplary” is not necessarily to be construed as preferred or advantageous over other examples. Additionally the terms “CDMA 1x”, “1xRTT”, and “1x” may be used interchangeably herein to denote any one of the various iteration of CDMA2000 1x standards or technologies. Furthermore, the term “LTE technology” as used herein encompasses various known technologies within 4G and includes, for example, LTE-Advanced Technology.

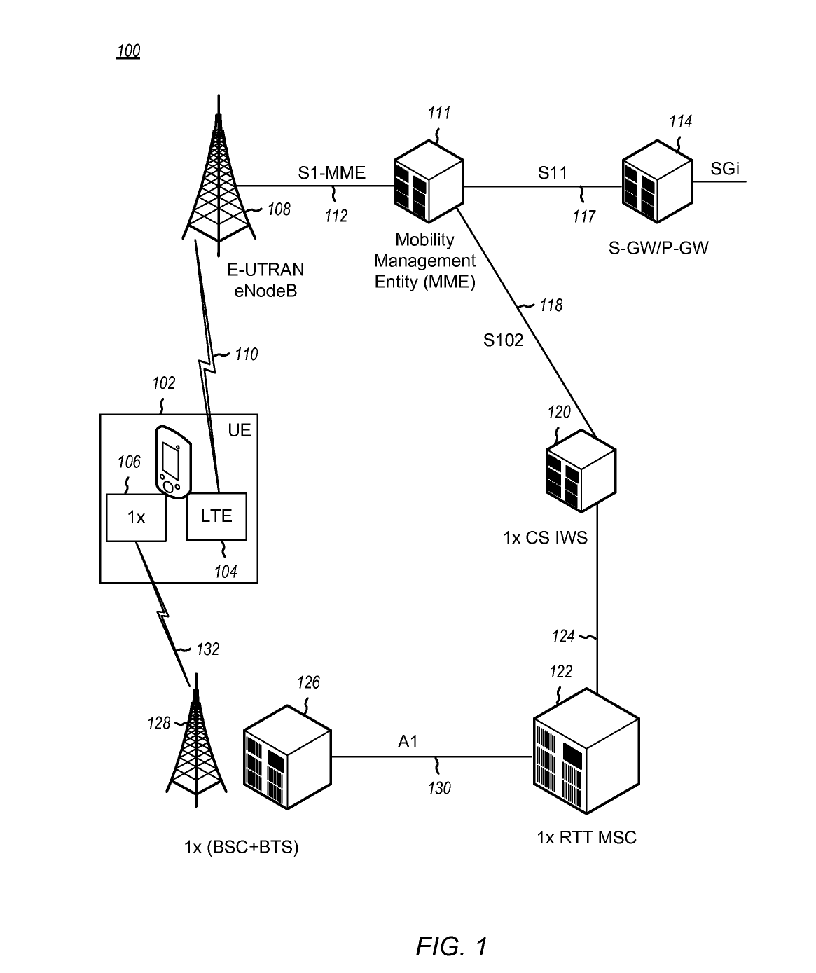

FIG. 1 illustrates a wireless environment 100 in which the present methods and apparatus may be employed. In particular, this figure illustrates a dual network wireless communication device 102 that includes support for both 1x CDMA and LTE, and the is described as a representative device herein. In some embodiments, the dual network single radio wireless communication device 102 includes support for the two different wireless networks using wireless circuitry that includes a single radio configurable to operate with each of the two wireless networks (i.e., SRLTE). The same teachings, however, can be applied to other wireless communication devices that can operate in dual (or more generally multiple) wireless communication technology networks with configurable hardware/software. In particular, the teachings disclosed herein can pertain to wireless communication devices that switch portions of wireless circuitry from one wireless technology to another wireless technology and back again, and which can be configured to receive communication from two different wireless networks simultaneously. Moreover, the wireless communication device can be configured to communicate bi-directionally with one wireless network while receiving and/or measuring signals from another wireless network simultaneously.

As illustrated, the environment 100 includes a UE 102 that is an SRLTE device operable in both LTE and CDMA 1x technologies, as illustrated by LTE portion 104 and CDMA 1x portion 106. It is noted at the outset, however, that it is conceivable that the present methods and apparatus may be applied to other types of UEs employable with other radio access technologies (RATs). That is, the presently disclosed call set up reducing and power saving methods and apparatus could be applied in other RATs where the mixed utilization of different portions of call set up procedures could afford realization of eliminating processes to reduce time, or, in the instance where one of the technologies uses an SCI or similar index, added power reduction capabilities by allowing cycling of power up of a UE to be reduced in frequency or extended in the periodicity.

The environment 100 may further include an E-UTRAN eNodeB 108 that effectuates wireless access for the UE 102 to an LTE radio access network via the LTE-Uu interface (110). The E-UTRAN 108 is in network communication with core network (CN) elements in the LTE evolved packet core (EPC) including a Mobility Management Entity (MME) 111 via an S1-MME interface 112 and Serving and PDN Gateways (S-GW/P-GW) 114 via an S1 interface (S1-U 116). According to the EPC model, MME 111 also is in communication with S-GW/P-GW 114 via an S11 interface 117. The core network is responsible for the overall control of the LTE UE and establishment of various bearers (i.e., a set of network parameters that define how UE data is treated when it travels across the network (e.g., providing a specific data rate for particular data, etc.)).

The MME 110, in particular, is the control node that processes the signaling between the UE 102 and the core network, but also processes signaling to other networks, such as a CDMA 1x network. The signaling between an LTE network and a CDMA 1x network is effectuated via an S102 tunnel or interface, as indicated in FIG. 1 by reference number 118. In particular, the 5102 interface 118 is established between the MME 110 and an Interworking gateway (1x CS IWS 120) for access to the 1x CMDA network. The IWS 120 is in network communication with a 1x RTT Mobile Switching Center (MSC) server 122 via an A1 interface 124. The MSC 122 is in communication with various base station controllers (BSC), such as BSC 126 and associated base transceiver stations (BTS 128) via A1 interfaces 130. The BTS 128 communicates with the UE 102, and the 1x portion 106, in particular, via wireless interface 132.

To better optimize LTE data performance, the present disclosure includes at least two methodologies (and associated apparatus) that can be used in the context of FIG. 1, for example. In particular, the first methodology involves increasing the SCI in a UE in order to effect a decreased frequency of 1x tune away, thus increasing the LTE optimization. The second methodology involves a process whereby the maximum SCI of the network may be requested to increase, thus allowing for the setting of greater SCI values. These methodologies, which are discussed below, may be implemented as standalone solutions or they can be implemented together for even better optimization.

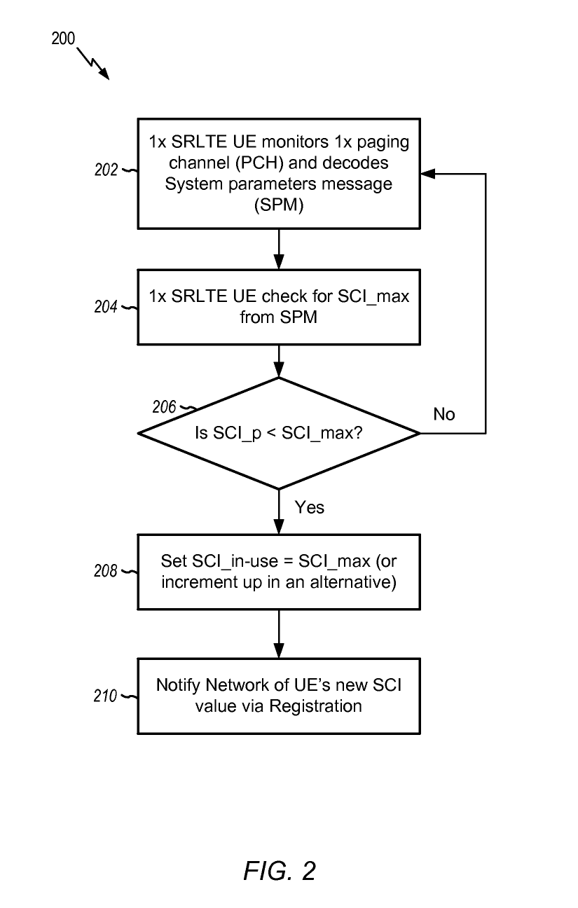

FIG. 2 illustrates a flow diagram of an exemplary method 200 for increasing the SCI within a UE device. This methodology involves configuring a UE, such as UE 102, to proactively increase the in-use Slot Cycle Index (SCI) from a smaller to a larger value in order to decrease the frequency of 1x tune away, thus reducing disruption to an LTE connected mode transferring data. Method 200 first involves the UE (e.g., a 1x SRLTE UE) monitoring the 1x paging channel (PCH) and decoding a System parameters message (SPM) from the Base Station (e.g., BSC+BTS 126, 128) as shown in block 202. The UE can then determine the network's maximum SCI (SCI_max) from the decoded SPM as shown at block 204. The UE itself has a preferred SCI programmed in its memory (termed herein as the SCIp). The UE may then determine if the preferred value of the SCI (SCIp) in the UE is less than the determined SCI_max as indicated by decision block 206. The degree to which the SCI value can be increased depends on the maximum SCI value. Thus, the comparison in block 206 is, in one sense, determining if the SCI_max will allow for increase of the UE's SCI. Thus, if the SCI_p is not less than the SCI_max, there is no room for further increase of the UE's SCI and flow returns back to block 202 for continued determination of the SPM from the monitored PCH.

If the SCI_p value is less than the SCI_max value as determined at block 206, however, then flow proceeds to block 208. Here, the UE in configured to set the SCI in use (SCI_M-use) equal to the SCI_max value in order to achieve a reduced frequency of 1x CDMA tune away. In an alternative aspect, instead of immediately increasing the SCI in use value to the maximum SCI, the value could be incremented, such as in units of one or in multiple units. After the increase in the SCI value, block 210 illustrates that the UE notifies the network (e.g., the LTE network) of the UE's new SCI value via registration messaging, as one example.

In another aspect, it is noted that the methodology of FIG. 2 could further implement a determination of the average 1x CDMA tune away time over a predetermined time period. Then, the SCI could be adjusted further based on whether the tune away is longer than the determined average tune away time, and also based on what degree of degradation of LTE data performance and 1x CDMA is experienced at the average tune away. This could allow a further determination of how much degradation could be tolerated for either technology, and based on network and/or user preferences how high the SCI could be adjusted without exceeding a tolerated degradation.

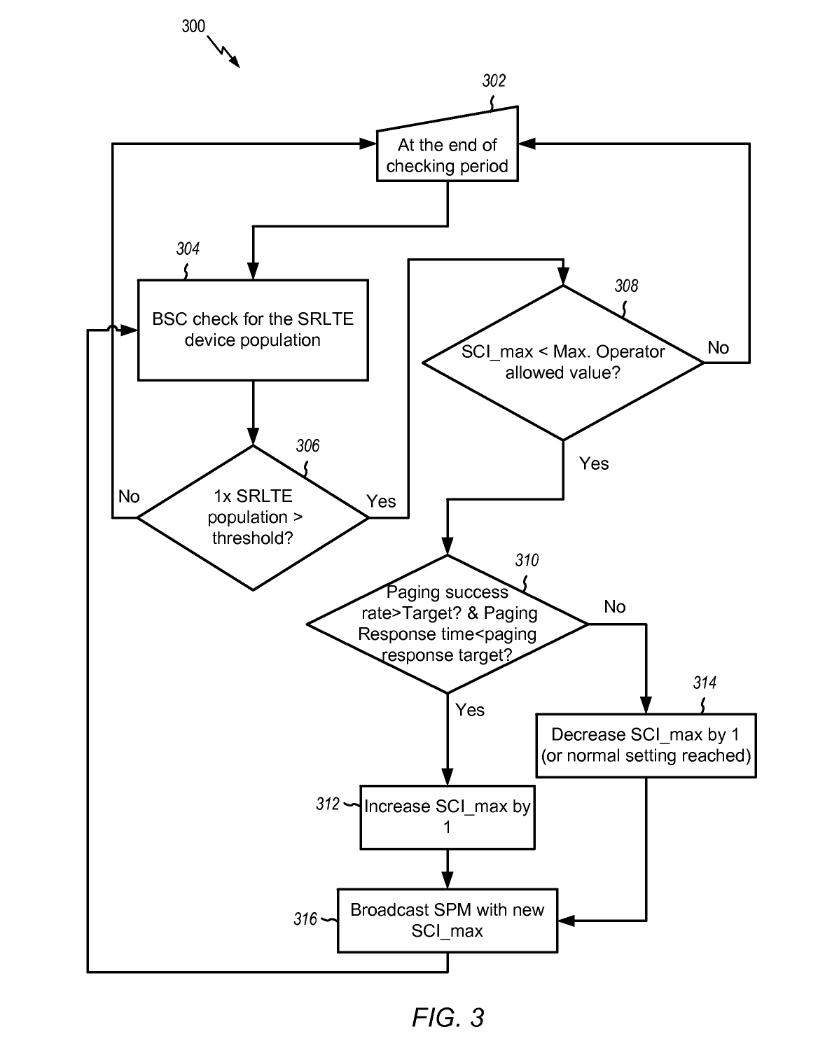

FIG. 3 illustrates a flow diagram of an exemplary method 300 for causing a network to increase the allowable or maximum SCI value. In method 300, the network is proactively directed to increase the maximum SCI (SCI_max), which benefits both 1xSRLTE and non-1xSRLTE devices at the expense of longer page response time.

As may be seen at process block 302, method 300, which may be implemented in a network station (e.g., a base station), begins after an evaluation period, where a checking time is at the end of the evaluation period. In an example, half-hourly or hourly checking could be sufficient as a Timer Registration value is typically between ½ hour and 1 hour. It is noted that the timing is not limited to such, however, and could be more or less. Flow proceeds to block 304 where the 1xSRLTE device population, location area wise, of such devices currently registered to a BSC, such as BSC 126, is determined. The determined population is compared to a population threshold as shown in block 306. In particular, if the population is not above the threshold, no further action is taken and flow reverts to block 302. It is noted that the processes of blocks 304 and 306 could be optional according to an aspect, as these steps are predominantly directed to determining if tuning of the SCI is feasible That is, the condition holds that when the SRLTE population is greater than a threshold then changing the MAX_SCI is allowed. If the SRLTE population is less than a threshold, however, the gain that benefits the SRLTE device is not enough to offset the consequence resulting from lowering the longer paging time that would also affect non-SRLTE devices. According to another aspect, it is noted that the determination of the SRLTE population could be effected on a Registration/Origination/Page Response received with a unique Electronic Serial Number (ESN) lot (i.e., to look for 1xSRLTE capable devices) during the evaluation time. Additionally, the threshold may be expressed as a predefined percentage.

In another example, the SRLTE population could also be determined from the Mobile Equipment Identifier (MEID). The MEID can be exchanged during a call through a “Status Request Message” and a “Status Response Message” pair where the 1x network sends the “Status Request message” and the UE replies with the “Status Response Message.” It is further noted that the use of other messages or message pairs is also contemplated for querying either the ESN or MEID, and that any other message(s) may be used that are suitable for achieving the query process for determining SRLTE population.

If the number of SRTLE devices (or percentage of SRLTE devices) in the local area exceed the predetermined threshold in block 306, then flow proceeds to decision block 308. Here, a determination is made whether the maximum SCI value (SCI_max) is less than a maximum value allowed by an operator. If not, then it is known that the SCI_max is at its allowable limit and no further increase may be accomplished. In such case, flow then returns back to block 302. It is noted that in typical situations, the SCI_max will be no more than 3, but method 300 is not necessarily limited to such and could encompass using higher SCI values.

Alternatively at block 308, if the SCI_max value is less than the maximum allowable SCI, flow then proceeds to decision block 310. Decision block 310 is used to determine whether two different conditions are met, and only upon meeting both conditions (i.e., an “AND” condition), will the SCI values be increased. In particular, block 310 first checks whether the paging success over the evaluation period is greater than a predefined target success rate. Additionally, block 310 determines if a paging response time over the evaluation period is less than a target paging response time. Thus, if the paging success rate exceeds a target rate, and the response time is quick such that it is less than a target response time, then it is permissible to further increase the maximum SCI value, thus decreasing the 1x CDMA tune away frequency. As indicated in the particular example of FIG. 3, block 312 illustrates that the method effectuates an incremental increase of one for the SCI_max value. On the other hand, if either of the two conditions in block 310 are not met, the SCI_max value may be decreased by a value of one (1), or if the SCI_max value is at the original or normal value, that value is maintained as indicated in block 314. The condition or value of SCI_max, as determined by either block 312 or 314, is then broadcast in the System Parameter Message (SPM). Further, the SPM may be set for each sector by sector or per a specific paging area.

The methodology of FIG. 3 therefore effects network tuning of the maximum SCI that is set by the network (i.e., MAX_SLOT_CYCLE_INDEX). Increasing the permissible maximum SCI can help a 1x SRLTE device converge faster without specification violation. This also may help non 1xSRLTE devices in terms of battery life saving. Thus, the methodology of FIG. 3 benefits both 1xSRLTE and non-1xSRLTE devices, but this is at the expense of longer page response time.

As mentioned before, the methodologies of FIGS. 2 and 3 may be implemented singularly, but could also be implemented together to realize increased LTE optimization. Benefits realized by these solutions may include improved user data experience for SRLTE devices by reducing the frequency of monitoring the paging channel and improved battery life of an SRLTE device, as well as non-SRLTE devices, through change of MAX_SLOT_CYCLE_INDEX.

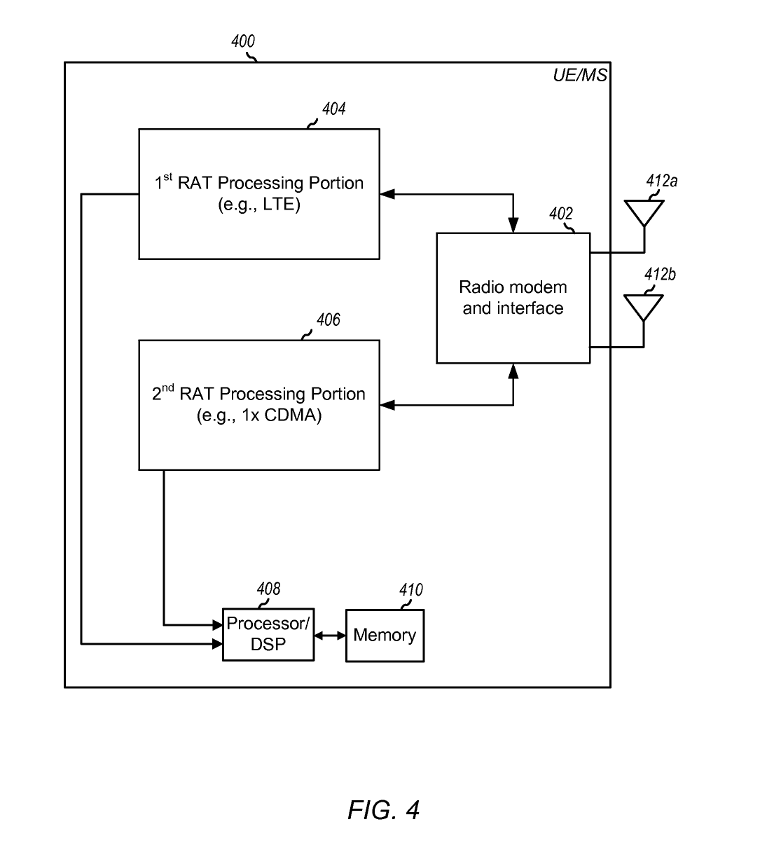

FIG. 4 illustrates a block diagram of an exemplary apparatus 400 that may implement the methods discussed above. In particular apparatus 400 may be a UE operable according to multiple RATs that includes a single radio or modem 402 for transmitting and receiving wireless signals from corresponding RATs (i.e., a SRLTE device), illustrated by block 402. Apparatus 400 further includes both a 1st RAT processing portion 404 (e.g., LTE signal processing) and a 2nd RAT processing portion 406 (e.g., 1x CDMA signal processing). The processing portions 404 and 406 both interface with modem/interface 402, which includes a suitable interface to correctly apportion received and transmitted signals of the multiple RATs to the corresponding processing portion 404 or 406.

Although not illustrated, each RAT portion 404, 406 may include data processing used for transmitting and receiving data via the different respective RATs. It is noted, that the configuration of FIG. 4 is merely one example for illustration purposes, and that actual internal configurations of devices 402, 404, 406 that might be contemplated by those skilled in the art are varied and need not be configured as shown. For example, the architecture of the modem may be configured with processing or modulation/demodulation to be shared among multiple RF Transmit/Receive circuits each performing their own associated baseband processing and RF conversions for transmission and reception.

In the configuration of FIG. 4, the apparatus 400 may include one or more processors and/or digital signal processing 408 along with an associated memory device(s) 410 that is configured to store computer-readable instructions or code accessible and executable by the processor(s) 408. Additionally, the modem/interface 402 is communicatively coupled to various multiple antenna 412 (e.g., 412a and 412b shown for illustrative purposes only) for transmitting and/or receiving wireless signals to or from an eNodeB (e.g., 108 in FIG. 1) and Base Station (e.g., 128 in FIG. 1).

The processor(s) 408 may control the operations of each of portions 404 and 406, as well as modem/interface 402. In operation, the UE 400 may implement one or more of the processes or operations illustrated in FIG. 2, 3, or 5 (to be discussed later). In particular, the processor(s) 408 may be configured to implement these processes, and coordinate attendant operations and functions carried out by modem/interface 402 and portions 404 and 406, and their various components. It is also noted that although the present apparatus and methods are described in conjunction with devices operable with LTE and 1x CDMA, it is noted that application of the concepts disclosed herein may be made to LTE Advanced, 3GPP based systems, GSM, UMTS, HSPA, CDMA, 1xEVDO, W-CDMA, other 3G and 4G technologies, IEEE 802.11 WiFi, WiFi direct, WPAN (IEEE 802.15), WiMax (IEEE 802.16), WiGig, MBWA (IEEE 802.20), cognitive radio (IEEE 802.22), Bluetooth®, or various other mesh network systems such as IEEE 802.11s, as merely a few examples.

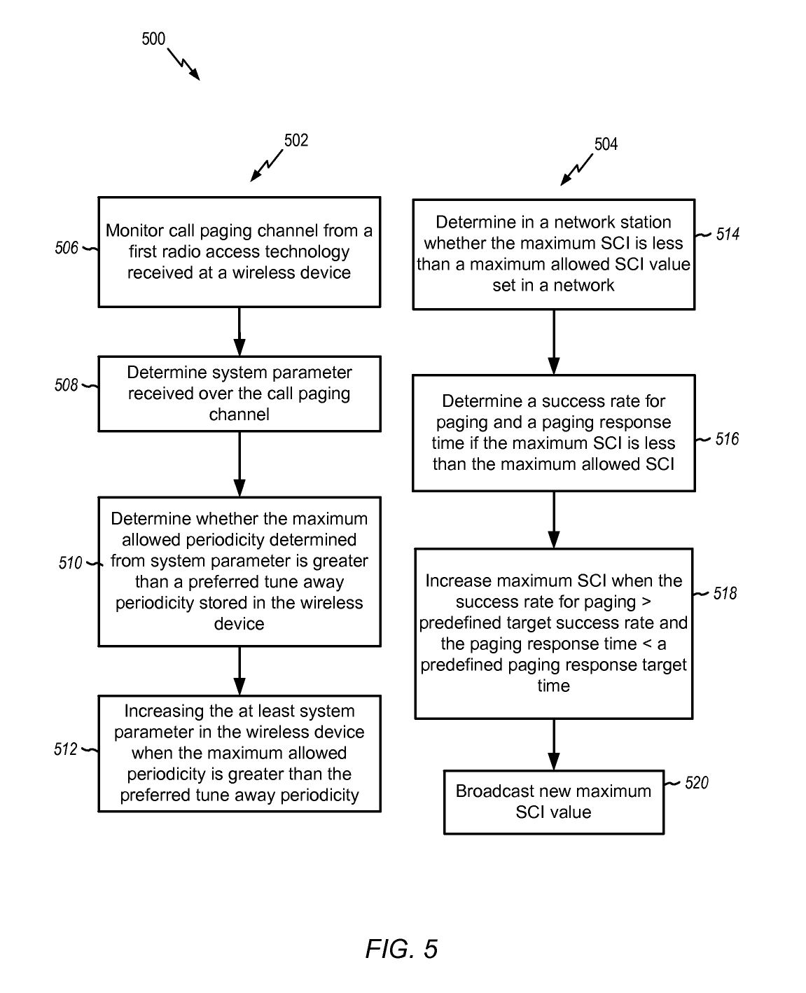

FIG. 5 illustrates an example of a method 500 for optimizing LTE data performance that combines features of the methods 200 and 300, discussed before. As may be seen in FIG. 5, method 500 includes two parallel procedures 502 and 504, which may be executed concomitantly, consecutively, or at independently different times. Procedure 502, which may be implemented within a UE, involves monitoring a call paging channel from a first radio access technology (e.g., a 1x CDMA RAT) received at a wireless device shown at block 506. As shown in block 508, procedure 502 further includes determining a system parameter(s) received over the call paging channel, such as the maximum SCI value from the SDM in the call paging channel. From the system parameter (e.g., the maximum SCI), procedure 502 includes determining whether the maximum allowed periodicity determined from system parameter is greater than a preferred tune away periodicity stored in the wireless device as shown at block 510. Finally at block 512, the tuning away periodicity of the wireless device is increased when the maximum allowed periodicity is greater than the preferred tune away periodicity. As has been discussed before, the increase in the periodicity of tuning away allows better performance for data on a second RAT (e.g., LTE) which is being tuned away from for monitoring of the first RAT (e.g., 1x CDMA).

The other procedure 504 in method 500 may be implemented in a network station or other network node, such as BTS 128. The procedure 504 includes process 514 that determines in the network station whether the maximum SCI is less than a maximum allowed SCI value set in a network. If the maximum SCI is less than the maximum allowed SCI as determined in process 514, then procedure 504 includes determining a success rate for paging and a paging response time as illustrated in block 516. If the the success rate for paging is greater than a predefined target success rate and the paging response time is less than a predefined paging response target time, the maximum SCI may then be increased, as shown in block 518. To what extent or gradation the maximum SCI value is increased is variable. In one aspect the value may be increased in increments of one (1). In other aspects the value could be increased by a multiple amount, such as 2 or 3, and in another the value could be simply taken to a maximum settable value (e.g., SCI=7). After the maximum SCI value has been increased, the network station may broadcast the new maximum SCI value in a locality (e.g., a cell or sector). In an aspect the broadcast is accomplished via the SPM message over the paging channel.

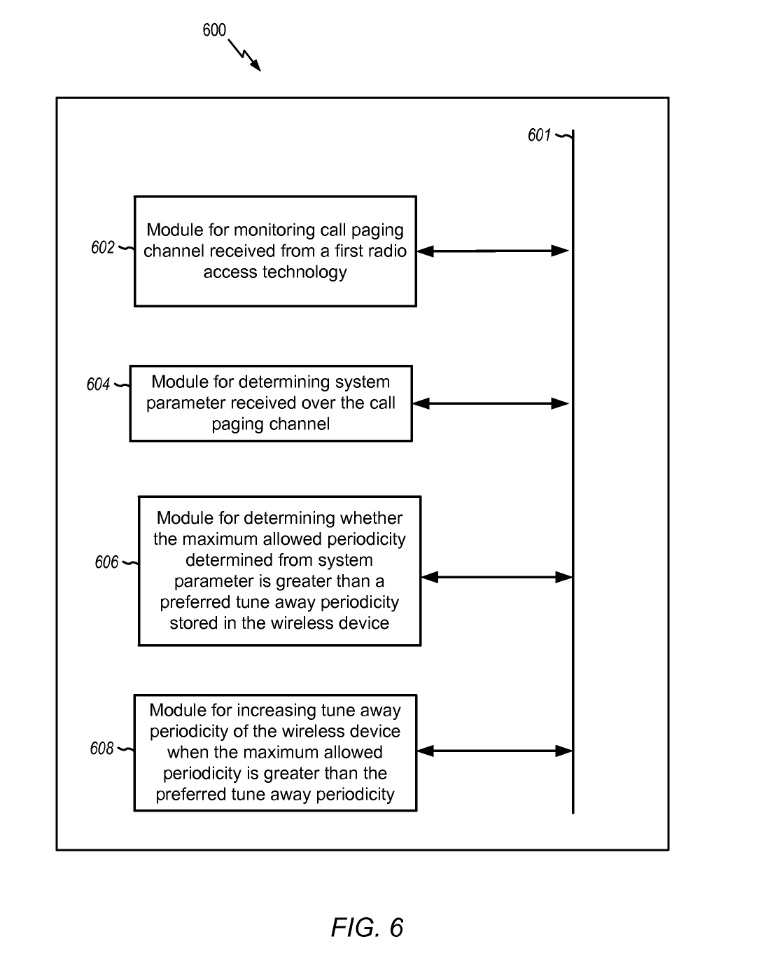

FIG. 6 illustrates another exemplary apparatus 600 that may be used to implement the processes or operations of FIGS. 2 and 5. Apparatus 600 is operable within a wireless device, such as a UE or MS. The apparatus 600 includes various modules, circuitry, or means that are configured for implementing SCI adjustment in order to optimize LTE performance within a dual mode UE or MS. Each of the modules, circuitry, or means in apparatus 600 are communicatively coupled, as illustrated by a communication bus 601 shown merely to indicate that the various means, blocks, modules, or circuitry within apparatus 600 are communicatively coupled and that communication of data and information occurs there between.

Apparatus 600 includes a means or module 602 for monitoring a call paging channel received from a first radio access technology. In particular, the module 602 may effect monitoring of the SDM in the call paging channel from a 1x CDMA system. In an aspect, module 602 may include a modem or radio in a UE/MS, as well as a processing portion or processor configured for digital signal processing that effects demodulation and decoding to obtain the SDM transmitted over the call paging channel. It is noted that portions or all of such processing may be implemented with a specific processor, such as an Application Specific Integrated Circuit (ASIC) or a field-programmable gate array (FPGA).

Additionally, apparatus 600 includes a module 604 for determining at least one system parameter received over the call paging channel. In an aspect, the system parameter is the maximum SCI value transmitted in the SDM. Module or means 604 may be implemented by a processing portion or processor configured for digital signal processing that effects demodulation and decoding to determine the parameter from the SDM transmitted over the call paging channel. It is noted that portions or all of such processing may be implemented with a specific processor, such as an Application Specific Integrated Circuit (ASIC) or a field-programmable gate array (FPGA).

Apparatus 600 also includes a module 606 for determining whether the maximum allowed periodicity determined from the system parameter (e.g., the SCI_max value) is greater than a preferred tune away periodicity stored in the wireless device. In an aspect, the preferred SCI (SCI_p) is compared with the maximum SCI (SCI_max) value to determine whether it is greater. This determination shows whether the SCI value in the wireless device has room to be increased, or if it is already at the maximum. Module or means 606 may be implemented by a processing portion or processor configured for digital signal processing that effects demodulation and decoding to determine the parameter from the SDM transmitted over the call paging channel. It is noted that portions or all of such processing may be implemented with a specific processor, such as an Application Specific Integrated Circuit (ASIC) or a field-programmable gate array (FPGA).

Furthermore, apparatus 600 includes a module or means 608 for increasing the tune away periodicity of the wireless device (i.e., increasing the SCI value) when the maximum allowed periodicity (i.e., SCI_max) is greater than the preferred tune away periodicity (i.e., SCI_p). Module 608 may be implemented by a processing portion or processor configured for digital signal processing that effects demodulation and decoding to determine the parameter from the SDM transmitted over the call paging channel. It is noted that portions or all of such processing may be implemented with a specific processor, such as an Application Specific Integrated Circuit (ASIC) or a field-programmable gate array (FPGA).

In another aspect, the first radio access technology may be a 1x CDMA and a second radio access technology is LTE. In a further aspect, means 602, 604, 606, and 608 could be implemented with the assistance of processor(s) 408 in FIG. 4, for example, and may also include elements 402, 404, and 406, and or any other equivalent devices or structures for carrying out the functions or methodologies disclosed herein.

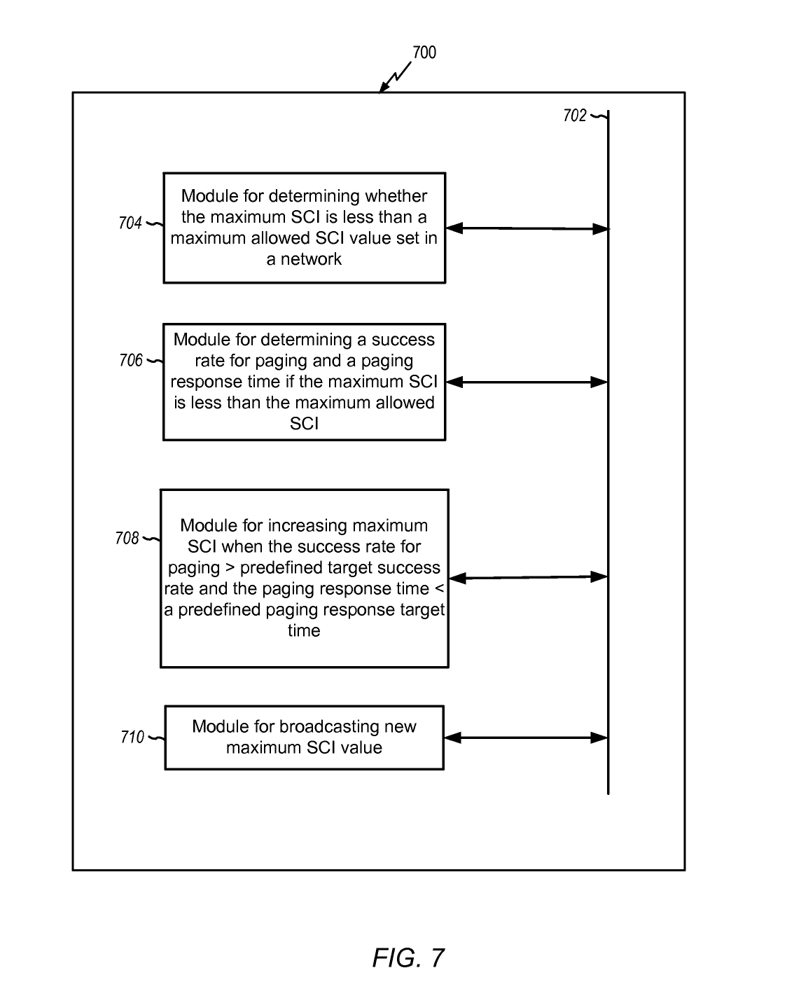

FIG. 7 illustrates an apparatus 700 that may be used to implement the processes or operations of FIGS. 3 and 5. Apparatus 700 is operable at a base station, such as a BTS 128 in FIG. 1. In another aspect, apparatus 700 is also operable in conjunction with UE or MSs in a wireless network. The apparatus 700 includes various modules, circuitry, or means that are configured for implementing SCI adjustment to allow UEs or MSs to be able to further increase their SCI values in order to optimize LTE performance within dual mode UEs or MSs. Each of the modules, circuitry, or means in apparatus 700 are communicatively coupled, as illustrated by a communication bus 702 shown merely to indicate that the various means, blocks, modules, or circuitry within apparatus 700 are communicatively coupled and that communication of data and information occurs there between.

Apparatus 700 includes a means or module 704 for determining whether a maximum SCI is less than a maximum allowed SCI value set in a network, such as an SCI maximum for a particular sector in a 1x CDMA network. In particular, the module 704 is configured for performing the determination and may be implemented with a specific processor, such as an Application Specific Integrated Circuit (ASIC) or a field-programmable gate array (FPGA). Additionally, apparatus 700 includes a module or means 706 for determining a success rate for paging and a paging response time if the maximum SCI is less than the maximum allowed SCI. This module or means 706 may be implemented by a processing portion or processor configured for digital signal processing that effects demodulation and decoding to determine the success rates and response times. It is noted that portions or all of such processing may be implemented with a specific processor, such as an Application Specific Integrated Circuit (ASIC) or a field-programmable gate array (FPGA).

Apparatus 700 also includes a module or means 708 for increasing maximum SCI when the success rate for paging is greater than a predefined target success rate and the paging response time is less than a predefined paging response target time. This increase, in turn, will allow UEs or MSs to potentially further increase the SCI values within the devices, such as through the method of FIG. 2 or 5. Module or means 708 may be implemented by a processing portion or processor configured for digital signal processing that effects demodulation and decoding to determine the parameter from the SDM transmitted over the call paging channel. It is noted that portions or all of such processing may be implemented with a specific processor, such as an Application Specific Integrated Circuit (ASIC) or a field-programmable gate array (FPGA).

Furthermore, apparatus 700 includes a module or means 710 for broadcasting the new maximum SCI value, particularly broadcast in a paging area, such as a sector in a particular cell. It is noted that portions or all of such processing may be implemented with a specific processor, such as an Application Specific Integrated Circuit (ASIC) or a field-programmable gate array (FPGA), as well as an encoder, modulator and RF transmitter.

In another aspect, a radio technology in the base station may be 1x CDMA. In a further aspect, means 704, 706, 708, and 710 could be implemented with the assistance of processor(s) in BTS 128 and BSC 126, for example, and may also include other equivalent devices or structures for carrying out the functions or methodologies disclosed herein.

In light of the above-disclosure, those skilled in the art will appreciate that allowing either a UE/MS or a base station to increase the SCI implemented in a UE/MS will afford a decrease in the periodicity of tune away from one RAT to another RAT (e.g., tune away from LTE to 1x CDMA), thus optimizing data performance for the RAT from which the UE/MS is being tuned away. It is noted that the present methods and apparatus may be particularly suitable in some countries that deploy 1xSRLTE+G devices in which subscribers of those markets could be primarily using GSM for voice (keeping a GSM number for MT call) but LTE/EVDO for data, and where 1x CDMA voice could be secondary choice for voice. These countries typically have no mobile number portability such that subscribers have to keep using old GSM number for keeping the old connection.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed examples is provided to enable any person skilled in the art to make or use the presently disclosed methods and apparatus. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method for optimizing the performance of a radio access technology in a wireless communication system supporting multiple radio access technologies, the method comprising:
monitoring a call paging channel from a first radio access technology received at a wireless device;
determining at least one system parameter received over the call paging channel, the at least one system parameter related to a maximum allowed periodicity of when the wireless device may tune away from a second radio access technology to monitor paging from the first radio access technology;
determining whether the maximum allowed periodicity determined from the at least one system parameter is greater than a preferred tune away periodicity stored in the wireless device; and
increasing the at least one system parameter in the wireless device when the when the maximum allowed periodicity is greater than the preferred tune away periodicity.

2. The method of claim 1, wherein the first radio access technology is a 1x CDMA technology and the second radio access technology is LTE technology.

3. The method as defined in claim 1, wherein the wireless device is a Single Radio LTE (SRLTE) user equipment.

4. The method as defined in claim 1, further comprising:
sending notification from the wireless device to a network concerning the increased at least one system parameter.

5. The method as defined in claim 1, wherein the at least one system parameter is a maximum slot cycle index (SCI) value.

6. The method as defined in claim 5, further comprising:
determining in a network station whether the maximum SCI is less than a maximum allowed SCI value set in a network;
determining a success rate for paging and a paging response time if the maximum SCI is less than the maximum allowed SCI; and
increasing the maximum SCI value when the success rate for paging is greater than a predefined target success rate and the paging response time is less than a predefined paging response target time.

7. The method as defined in claim 6, further comprising:
broadcasting the increased maximum SCI value from the network station in the call paging channel for a specific paging area.

8. The method as defined in claim 6, further comprising:
decreasing the maximum SCI value if at least one of the success rate for paging is less than a predefined target success rate and the paging response time is greater than a predefined paging response target time.

9. A device configured for optimizing the performance of a radio access technology in a wireless communication system supporting multiple radio access technologies, the device comprising:
at least one processor configured for:
monitoring a call paging channel from a first radio access technology received at a wireless device;
determining at least one system parameter received over the call paging channel, the at least one system parameter related to a maximum allowed periodicity of when the wireless device may tune away from a second radio access technology to monitor paging from the first radio access technology;
determining whether the maximum allowed periodicity determined from the at least one system parameter is greater than a preferred tune away periodicity stored in the wireless device; and
increasing the at least one system parameter in the wireless device when the when the maximum allowed periodicity is greater than the preferred tune away periodicity.

10. The device of claim 9, wherein the first radio access technology is a 1x CDMA technology and the second radio access technology is LTE technology.

11. The device as defined in claim 9, wherein the wireless device is a Single Radio LTE (SRLTE) user equipment.

12. The device as defined in claim 9, further comprising:
sending notification from the wireless device to a network concerning the increased at least one system parameter.

13. The device as defined in claim 9, wherein the at least one system parameter is a maximum slot cycle index (SCI) value.

14. The device as defined in claim 13, the at least one processor further configured for:
determining in a network station whether the maximum SCI is less than a maximum allowed SCI value set in a network;
determining a success rate for paging and a paging response time if the maximum SCI is less than the maximum allowed SCI; and
increasing the maximum SCI value when the success rate for paging is greater than a predefined target success rate and the paging response time is less than a predefined paging response target time.

15. The device as defined in claim 14, the at least one processor further configured for:
broadcasting the increased maximum SCI value from the network station in the call paging channel for a specific paging area.

16. The device as defined in claim 14, the at least one processor further configured for:
decreasing the maximum SCI value if at least one of the success rate for paging is less than a predefined target success rate and the paging response time is greater than a predefined paging response target time.

17. An apparatus for optimizing the performance of a radio access technology in a wireless communication system supporting multiple radio access technologies, the apparatus comprising:
means for monitoring a call paging channel from a first radio access technology received at a wireless device;
means for determining at least one system parameter received over the call paging channel, the at least one system parameter related to a maximum allowed periodicity of when the wireless device may tune away from a second radio access technology to monitor paging from the first radio access technology;
means for determining whether the maximum allowed periodicity determined from the at least one system parameter is greater than a preferred tune away periodicity stored in the wireless device; and
means for increasing the at least one system parameter in the wireless device when the when the maximum allowed periodicity is greater than the preferred tune away periodicity.

18. The apparatus of claim 17, wherein the first radio access technology is a 1x CDMA technology and the second radio access technology is LTE technology.

19. The apparatus as defined in claim 17, wherein the wireless device is a Single Radio LTE (SRLTE) user equipment.

20. The apparatus as defined in claim 17, further comprising:
sending notification from the wireless device to a network concerning the increased at least one system parameter.

21. The apparatus as defined in claim 17, wherein the at least one system parameter is a maximum slot cycle index (SCI) value.

22. The apparatus as defined in claim 21, further comprising:
means for determining in a network station whether the maximum SCI is less than a maximum allowed SCI value set in a network;
means for determining a success rate for paging and a paging response time if the maximum SCI is less than the maximum allowed SCI; and
means for increasing the maximum SCI value when the success rate for paging is greater than a predefined target success rate and the paging response time is less than a predefined paging response target time.

23. The apparatus as defined in claim 22, further comprising:
means for broadcasting the increased maximum SCI value from the network station in the call paging channel for a specific paging area.

24. The apparatus as defined in claim 22, further comprising:
means for decreasing the maximum SCI value if at least one of the success rate for paging is less than a predefined target success rate and the paging response time is greater than a predefined paging response target time.

25. A computer program product comprising computer-readable medium comprising:
code for causing a computer to monitor a call paging channel from a first radio access technology received at a wireless device in a wireless communication device supporting multiple radio access technologies;
code for causing a computer to determine at least one system parameter received over the call paging channel, the at least one system parameter related to a maximum allowed periodicity of when the wireless device may tune away from a second radio access technology to monitor paging from the first radio access technology;
code for causing a computer to determine whether the maximum allowed periodicity determined from the at least one system parameter is greater than a preferred tune away periodicity stored in the wireless device; and
code for causing computer to increase the at least one system parameter in the wireless device when the when the maximum allowed periodicity is greater than the preferred tune away periodicity.

26. The computer program product of claim 25, wherein the first radio access technology is a 1x CDMA technology and the second radio access technology is LTE technology.

27. The computer program product of claim 25, wherein the wireless device is a Single Radio LTE (SRLTE) user equipment.

28. The computer program product of claim 25, the computer-readable medium further comprising:
code for causing a computer to send notification from the wireless device to a network concerning the increased at least one system parameter.

29. The computer program product of claim 25, wherein the at least one system parameter is a maximum slot cycle index (SCI) value.

30. The computer program product of claim 29, further comprising:
code for causing a computer to determine in a network station whether the maximum SCI is less than a maximum allowed SCI value set in a network;
code for causing a computer to determine a success rate for paging and a paging response time if the maximum SCI is less than the maximum allowed SCI; and
code for causing a computer to increase the maximum SCI value when the success rate for paging is greater than a predefined target success rate and the paging response time is less than a predefined paging response target time.
